(19) United States
(12) Patent Application Publication
(10) Pub. No.: US 2020/0105261 A1
(43) Pub. Date: Apr. 2, 2020

(54) INTELLIGENT PORTABLE VOICE ASSISTANT SYSTEM

(71) Applicant: Senstone Inc., Redwood City, CA (US)

(72) Inventors: Maksym Titov Oleksandrovych, Lviv (UA); Nazar Fedorchuk, San Francisco, CA (US); Oleksii Oliinyk, Kyiv (UA)

(21) Appl. No.: 16/483,697

(22) PCT Filed: Feb. 2, 2018
(86) PCT No.: PCT/US2018/016683

§ 371 Date: Aug. 5, 2019

Related U.S. Application Data
(60) Provisional application No. 62/454,816, filed on Feb. 5, 2017.

(51) Int. Cl. G10L 15/22; G10L 15/16; G10L 21/0216; G10L 25/78; G10L 13/08; H04R 1/40

(52) U.S. Cl. CPC G10L 15/22; G10L 15/16; G10L 21/0216; G10L 2015/227; G10L 13/08; H04R 1/406; G10L 25/78

(57) ABSTRACT

A highly integrated portable voice assistant system is disclosed that may, among other things, provide the ability to easily memorialize all of the things you want to remember at a moment's notice, and keeping it all at your fingertips, across all of your devices, no matter where you are, as well as the ability to extract useful information from voice and ambient noise signals recorded from two or more microphones of a portable recorder device using artificial intelligence.

### RELATED APPLICATIONS

The present application claims priority to U.S. Provisional Application No. 62/454,816, filed Feb. 5, 2017 entitled “The Bluetooth Voice Recorder with Artificial Intelligence,” which is hereby incorporated by reference in its entirety. The present application is further related to U.S. Design application Ser. No. 29/597,822, filed Mar. 20, 2017, entitled “Electronic Device,” which is hereby incorporated by reference in its entirety.

### TECHNICAL FIELD

Embodiments herein relate generally to audio recording systems and, more specifically, to highly integrated portable audio recorder systems for intelligently recording and analyzing voice and ambient noise signals.

### BACKGROUND

Having the ability to easily memorialize all of the things you want to remember at a moment's notice, and keeping it all at your fingertips, across all of your devices, no matter where you are, may be a challenge. For example, taking notes by hand requires typing the notes on a piece of paper or in a document, both of which can be cumbersome. Conventional recording devices typically require carrying a separate device (e.g., a Dictaphone), and manually syncing recordings from such devices with other devices may be difficult, if not impossible. Similarly, note-taking applications, including those that can be accessed from a mobile phone device, typically require accessing one's mobile device, manually activating the application to start and stop a recording, and manually synching the recording with other devices. Moreover, neither conventional recording devices nor note-taking applications may extract and analyze recorded audio to provide useful information about the context in which the audio was captured. Accordingly, what is needed is an intelligent portable voice recording system.

### SUMMARY

Provided herein are intelligent audio recording systems. These intelligent recording systems, consistent with the disclosed embodiments, may include a portable recorder device comprising two or more microphones, one or more processors, and a communication interface for communication with a user device, one or more remote servers, or another recorder device. One of the two or more microphones may be operable to capture a voice signal from recorded audio and an other of the two or more microphones may be operable to capture an ambient sound/noise signal from the audio. The voice signal may be analyzed by the portable recorder device itself or one or more remote servers to generate one or more voice files. Similarly, the ambient noise signal may be analyzed by the portable device itself or one or more remote servers to generate one or more noise files. Such analysis may be done using artificial intelligence. The voice files and ambient noise files may be used by an application on a user device to, among other things, display, manipulate, categorize, time stamp and tag textual notes corresponding to the recorded audio and provide other useful information related to the recorded audio.

### BRIEF DESCRIPTION OF THE DRAWINGS

The written disclosure herein describes illustrative embodiments that are non-limiting and non-exhaustive. Reference is made to certain illustrative embodiments that are depicted in the figures, wherein:

FIG. 1A illustrates a simplified diagram of an intelligent recording system consistent with embodiments of the present disclosure;

FIG. 1B illustrates a simplified diagram of an intelligent recording system consistent with embodiments of the present disclosure;

FIG. 2A illustrates an exploded perspective view of an exemplary recorder device consistent with embodiments of the present disclosure;

FIG. 2B illustrates an exploded perspective view of another exemplary recorder device consistent with embodiments of the present disclosure;

FIG. 3A illustrates a surface view of an exemplary printed circuit board of a recorder device consistent with embodiments of the present disclosure;

FIG. 3B illustrates an opposite surface view of the exemplary printed circuit board of the recorder device consistent with embodiments of the present disclosure;

FIG. 4A illustrates a flow diagram of an exemplary recording system consistent with embodiments of the present disclosure;

FIG. 4B illustrates a modified flow diagram of the exemplary recording system of FIG. 4A consistent with embodiments of the present disclosure;

FIG. 4C illustrates a flow diagram of an exemplary recording system consistent with embodiments of the present disclosure;

FIG. 4D illustrates a modified flow diagram of the exemplary recording system of FIG. 4C consistent with embodiments of the present disclosure;

FIG. 5 illustrates a top view of a stylized recorder device worn as a pendant consistent with embodiments of the present disclosure;

FIG. 6 illustrates a side view of a stylized recorder device worn on a bracelet consistent with embodiments of the present disclosure;

FIG. 7 illustrates a top perspective view of a stylized recorder device worn with a band consistent with embodiments of the present disclosure; and

FIG. 8 illustrates a front view of a stylized recorder device worn clipped to an article of clothing consistent with embodiments of the present disclosure.

### DETAILED DESCRIPTION OF ILLUSTRATIVE EMBODIMENTS

A detailed description of the embodiments of the present disclosure is provided below. While several embodiments are described, the disclosure is not limited to any one embodiment, but instead encompasses numerous alternatives, modifications, and equivalents. In addition, while numerous specific details are set forth in the following description to provide a thorough understanding of the embodiments disclosed herein, some embodiments can be practiced without some or all of these details. Moreover, for clarity, certain technical material that is known in the related art has not been described in detail to avoid unnecessarily obscuring the disclosure.

The description may use perspective-based descriptions such as up, down, back, front, top, bottom, interior, and exterior. Such descriptions are used merely to facilitate the discussion and are not intended to restrict the application of disclosed embodiments. The description may also use perspective-based terms (e.g., top, bottom, etc.). Such descriptions are also merely used to facilitate the discussion and are not intended to restrict the application of disclosed embodiments.

The description may use the terms “embodiment” or “embodiments,” which may each refer to one or more of the same or different embodiments. The terms “comprising,” “including,” “having,” and the like, as used with respect to embodiments, are synonymous, and are generally intended as “open” terms e.g., the term “includes” should be interpreted as “includes but is not limited to,” the term “including” should be interpreted as “including but not limited to,” and the term “having” should be interpreted as “having at least.”

Regarding the use of any plural and/or singular terms herein, those of skill in the relevant art can translate from the plural to singular and/or from the singular to the plural as is appropriate to the context and/or application. The various singular and/or plural permutations may be expressly set forth herein for the sake of clarity.

The embodiments of the disclosure may be understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the step be executed only once, unless otherwise specified.

Various embodiments of the present disclosure provide intelligent recording device systems that may, among other things, provide the ability to easily memorialize all of the things you want to remember at a moment's notice, and keeping it all at your fingertips, across all of your devices, no matter where you are, as well as the ability to extract useful information from recorded audio, including intonation, environmental surroundings, and the like. To accomplish these objectives, intelligent recording systems disclosed herein may comprise a stylized wearable device with wireless communication capability (e.g., Bluetooth, etc.) for recording both voice and ambient audio. The intelligent recording systems disclosed herein may also comprise the capability to save voice memos (i.e., voice recordings) and ambient audio to storage, including cloud storage; transmit voice memos and other audio recordings to one or more Bluetooth-enabled devices (e.g., smartphone, automobile, television, LED screen, or any other device); convert voice memos to text and organize the converted text based on one or more pre-defined keywords and/or themes; and analyze audio recordings for voice intonation, voice identification, ambient environment noise, and the like, using artificial intelligence or other intelligent computing approaches.

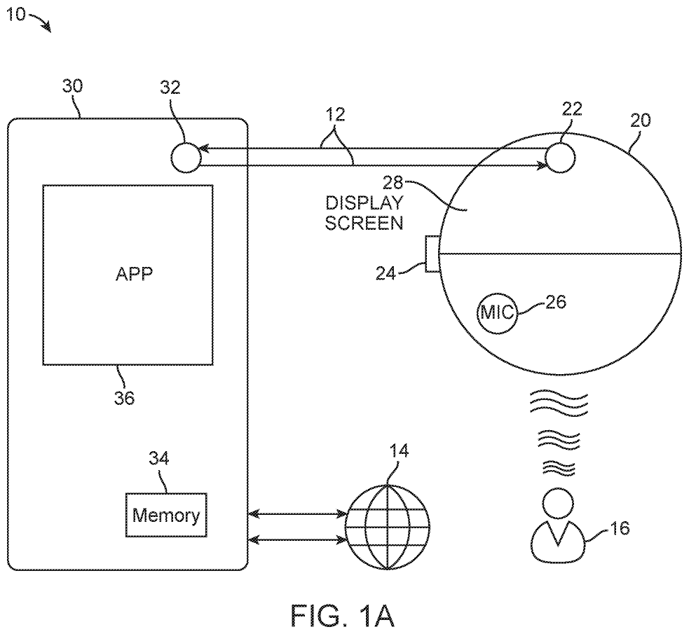

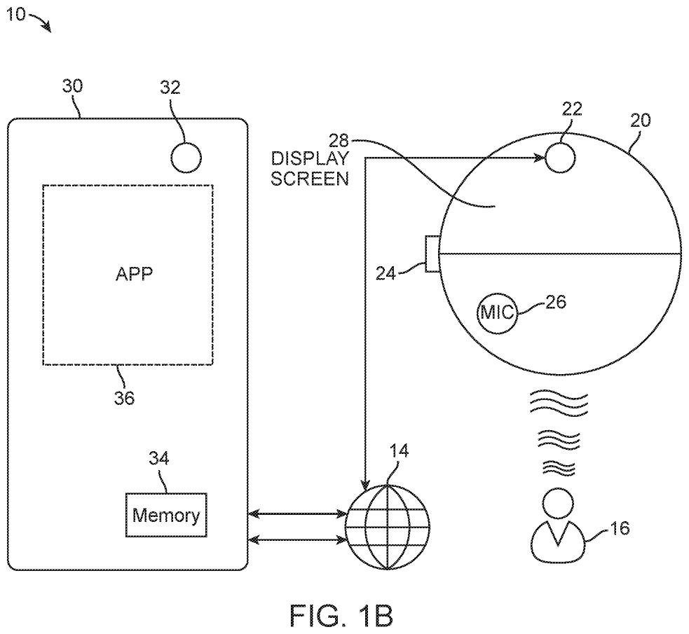

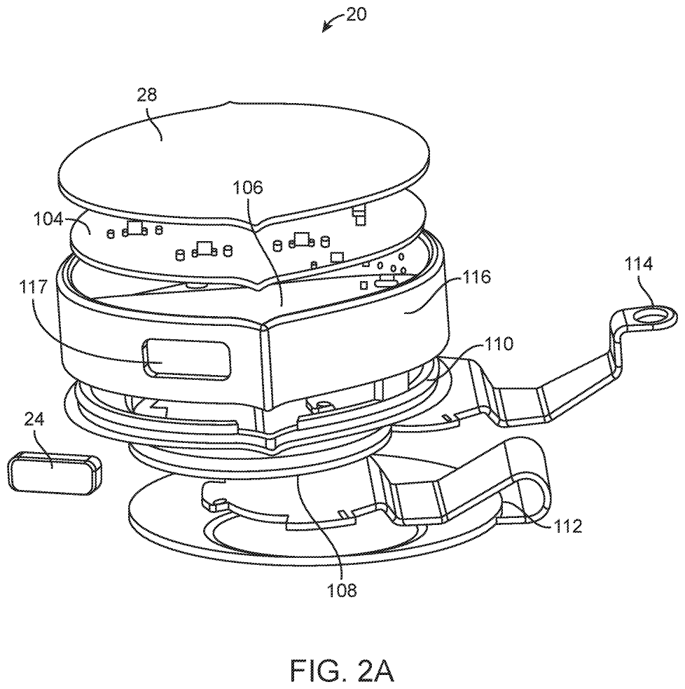

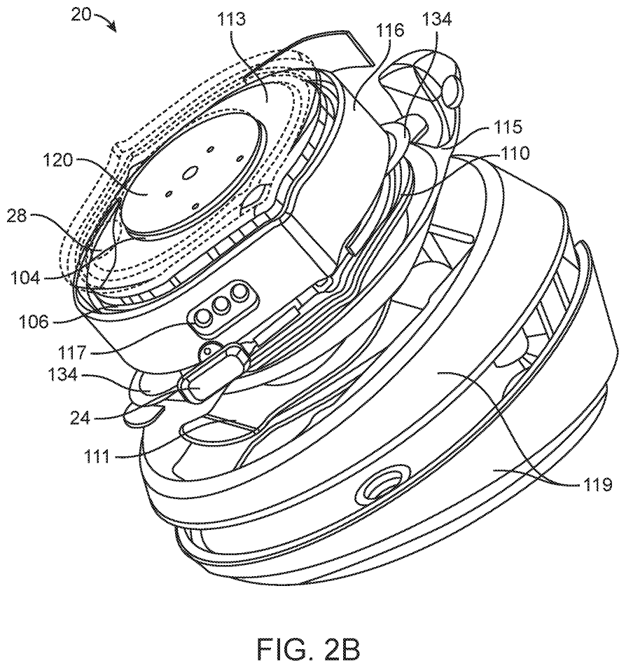

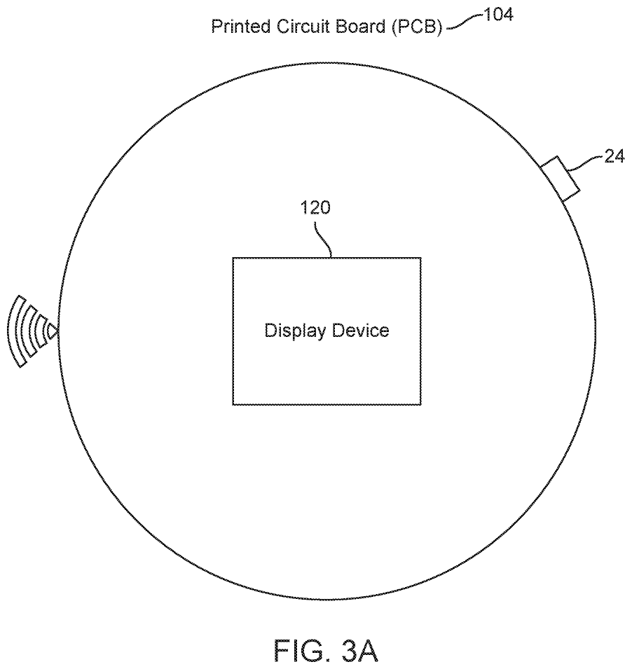

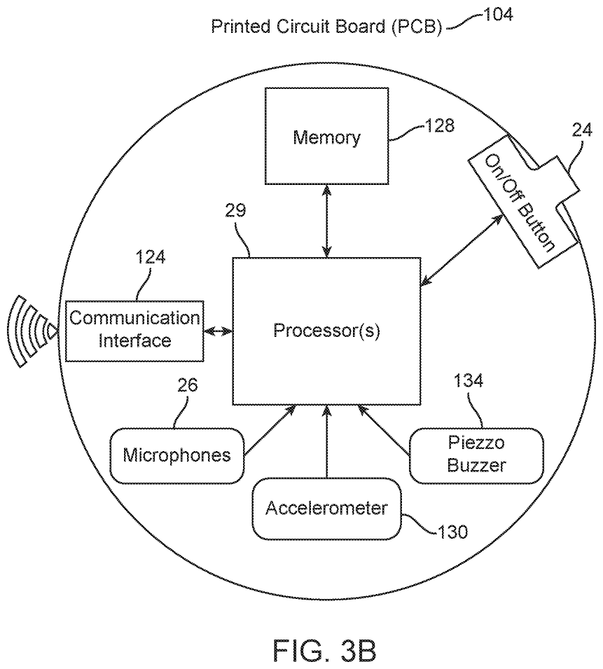

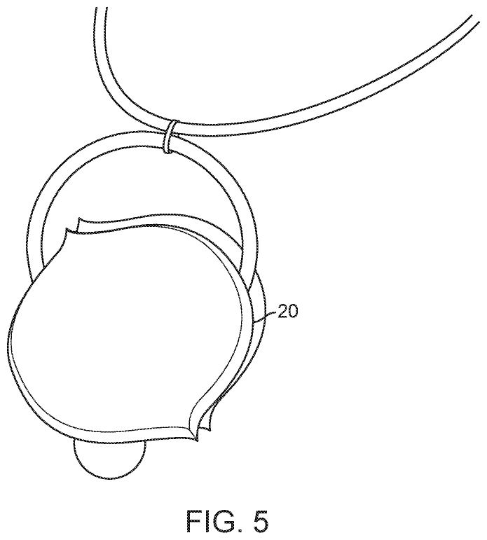

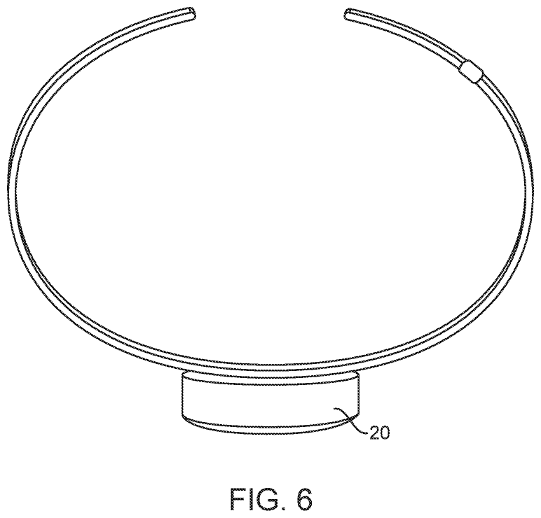

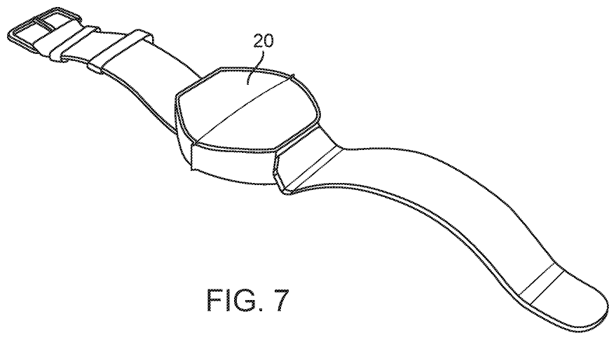

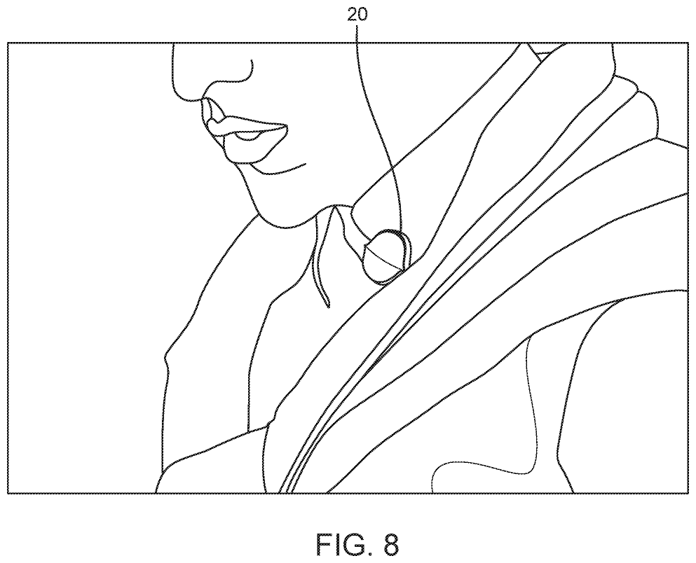

FIGS. 1A and 1B, show simplified diagrams of an exemplary intelligent voice recording system in accordance with various embodiments herein. The system 10 may comprise an electronic recorder device 20 for capturing audio. The recorder device 20 may use two or more microphones 26 that may be configured to capture voice and ambient sounds or noise. The recorder device 20 may be carried or worn by a user 16 in a number of ways, including as a pendant (FIG. 5), on a bracelet (FIG. 6), attached to a watch band (FIG. 7), or clipped to an article, including an article of clothing (FIG. 8). The recorder device 20 may also be used from a carrier station that provides charging and cloud synchronization functionality. The recorder device 20 may comprise an antenna 22 for wireless communication. And, as discussed in detail with reference to FIGS. 2 and 3, the recorder device 20 may comprise various other components, including an on/off button 24, and display screen 28.

As shown in FIG. 1A, the system 10 may further comprise a user device 30 coupled to the recorder device 20 via a wireless connection 12, such as a Bluetooth connection or any other wireless connection. The user device 30 may comprise an antenna 32 for wireless communication with a recorder device 20. Data exchanged between the user device 30 and the recorder device 20 via the wireless connection 12 may comprise, among other things, audio recorded by the recorder device 20, information derived from the audio recorded by the recorder device 20 (e.g., textual notes, prosodic characteristics of speech, emotional characteristics of speech, the environment in which speech was made, etc.), GPS location of the user device 30, and functional assignments for the on/off button 24 of the recorder device 20. In some embodiments, as shown in FIG. 1B, instead of exchanging the data mentioned above directly with the recorder device 30, the user device 30 may receive such data from one or more servers 14. A variety of user devices 30 may be used in accordance with embodiments disclosed herein including, for example, a smartphone, tablet, or other mobile device, automobile, television, LED screen, or any other device or unit that is capable of communicating with the recorder device 20 via a wireless connection 12. The user device 30 may comprise local memory 34, which may be used for storing data received from the recorder device 20.

The user device 30 may be coupled to one or more servers 14, including but not limited to cloud servers, that are capable of storing and/or processing audio (or information derived from audio) captured by a recorder device 20. The one or more servers 14 may be located remotely (as illustrated), such as when coupled via a computer network or cloud-based network, including the Internet, and/or locally, including on the user device 30. A server 14 may comprise a virtual computer, dedicated physical computing device, shared physical computer or computers, or computer service daemon, for example. A server 14 may comprise one or more processors such as central processing units (CPUs), natural language processor (NLP) units, graphics processing units (GPUs), and/or one or more artificial intelligence (AI) chips, for example. In some embodiments, a server 14 may be a high-performance computing (HPC) server (or any other maximum performance server) capable of accelerated computing, for example, graphics processing unit (GPU) accelerated computing.

The user device 30 may further comprise application specific software (e.g., a mobile app) 36 that may, among other things, receive audio captured (or information derived from audio captured) by a recorder device 20; store/retrieve audio captured by a recorder device 20 (or information derived from audio captured by a recorder device 20) in/from a local memory 34 of the user device 30; store/retrieve information derived from audio captured by a recorder device 20 (or information derived from audio captured by a recorder device 20) on/from a server 14; transmit audio captured by a recorder device 20 to a server 14 for processing (e.g. voice-to-text translation, audio analysis using neural processing, etc.); perform location and meta tagging analysis of information derived from audio captured by recorder device 20 (e.g., analysis of textual notes, etc.); perform keyword and conceptual analysis of information derived from audio captured by recorder device 20 (e.g., analysis of textual notes, etc.); and sort information derived from audio captured by recorder device 20 (e.g., sort notes by subject matter categories, etc.) depending upon results of the keyword and conceptual analysis.

For example, in an exemplary scenario, the user 16 may talk to a recorder device 20 and list the items that s/he wants to save as a to-do-list for preparing for a birthday party by saying, “Checklist, invite friends, buy a cake, find a present, decorate, win, animator” into the recorder device 20. Once the recorder device 20 stops recording, captured audio is transmitted to the user device 30 where it is received by the mobile app 36 running on the user device 30. Upon receiving the audio, the mobile app 36 may send it to a server 14 where the audio goes through a speech-to-text conversion process, or save the audio to local memory 34 and send it to a server 14 at a later time. The transcribed text may be received back from the server 14 at the mobile app 36, where the mobile app 36 checks the first word in the text for a command keyword, and then saves the remaining transcribed text. In this example, because the command keyword is “Checklist,” the remaining text is saved in a Checklists category of the mobile app 36 where it can be displayed to a user 16 via the mobile app 36, and where the checklist can be manipulated by the user 16 via the mobile app 36 (or otherwise), including checking off items on the list, editing items on the list, deleting items from the list, etc.

In another exemplary scenario, a user 16 may use the recorder device 20 to post information to a social media site by saying, for example, “Twitter, what I am witnessing now is the warmest winter day in New York since I have lived here” to the device 20. Here again, once the recorder device 20 stops recording, audio captured by the recorder 20 may be transmitted to the user's device 30, where it is received by the mobile app 36. Upon receiving the audio, the mobile app 36 may send the audio to a server 14 for speech-to-text conversion, or save the audio to local memory 34 and send it to a server 14 at a later time. Once the transcribed text is received back from the server 14 by the mobile app 36, the mobile app 36 may check the first word in the transcribed text for a command keyword, and save the remaining transcribed text. In this example, because the command keyword is “Twitter,” the mobile app 36 may automatically post the remaining transcribed text on the user's 16 Twitter account.

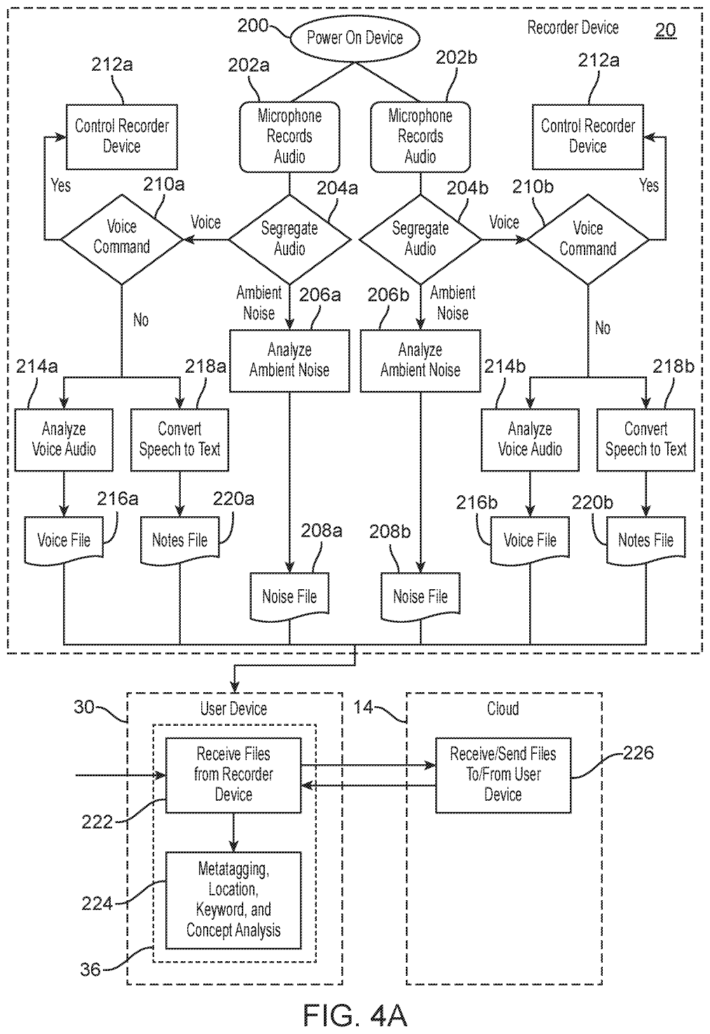

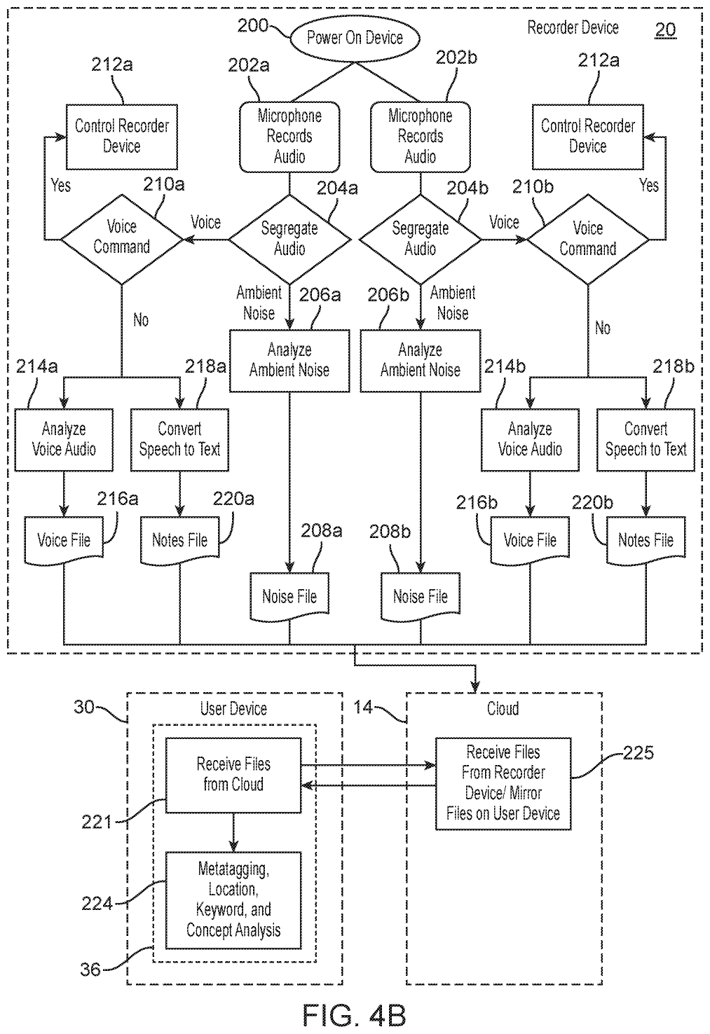

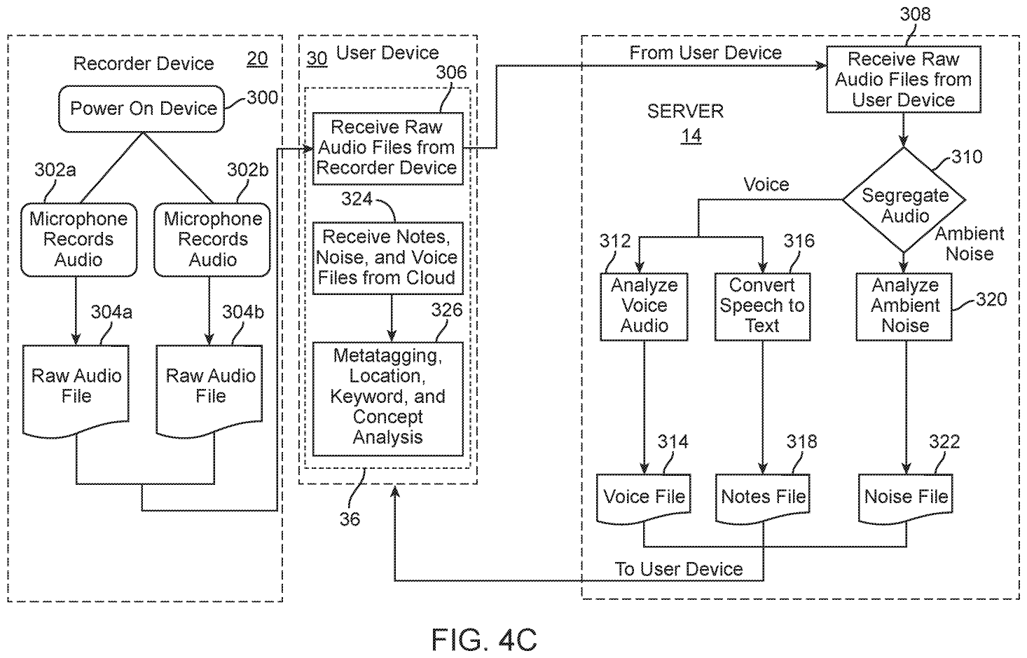

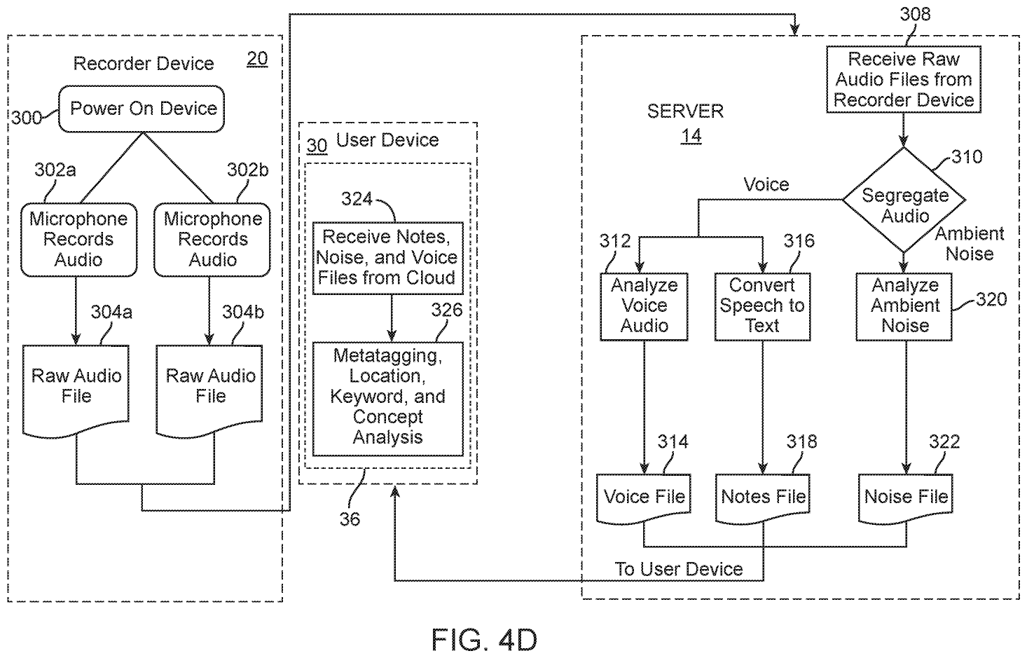

The exemplary scenarios mentioned above are for illustrative purposes only and are not meant to limit the scope of the present disclosure. Thus, numerous other scenarios, command keywords, and/or corresponding mobile application categories are possible, including calendar, diary notes, music, lists (e.g., shopping list, checklist, to-do list, etc.), reminders, social media, etc. Moreover, as discussed with reference to FIG. 4, instead of receiving raw audio from a recorder device 20 and sending the raw audio to a server 14 for processing (as described in the exemplary scenarios), the raw audio may be processed by the recorder device 20 itself. In this case, transcribed text (as well as other information derived from the raw audio processing) may be sent by the recorder device 20 to the user device 30 (or directly to a server 14), where it is eventually used by the mobile app 36 as in the exemplary scenarios discussed above.

There are generally three different manners in which a user 16 may interact with the system 10 of FIG. 1. In one case, the mobile app 36 on the user device 30 is closed, and the user device 30 is coupled to (and within communication range with) the recorder device 20. In this case, the user device 30 may receive audio from the recorder device 20, decompress the audio and transmit it to a server 14 for processing and analysis, receive the results text notes, etc.) back from the server 14, and automatically sort the results. Then, once the mobile app 36 is opened, the user 16 will see a certain number of new notes in the app 36 and may accept or reject them.

In another case, the recorder device 20 is recording, and is out a communication range with the user device 30. In this case, audio is stored on a user device 30 and later transmitted to the user device 30 once the wireless connection is restored, at which point the process proceeds as described above. In yet another case, the mobile app 36 on the user device 30 is open or running in the background, the user device 30 is coupled to (and within range of ) the recorder device 20, and the recorder device 20 is recording. In this case, the audio may be received and processed instantaneously.

In accordance with various embodiments herein, and with reference to FIGS. 1A and 1B, exemplary electronic recorder devices 20 are illustrated in FIGS. 2A and 2B. As illustrated in FIG. 2A, the recorder device 20 may comprise a screen 28 through which graphical (e.g., icons, figures, etc.) and/or textual information may be displayed. For example, the screen 28 may indicate, among other things: that the recorder device 20 is turned on or off; that a reminder is going off the start/end of recording; the device 20 is transmitting/receiving data, the device 20 is charging; low battery; or other functional modes of the device 20. The screen 28 may also act as an interface for touch commands that control the recorder device 20, including tapping the screen 28. For example, in some embodiments, the recorder device 20 may respond to tapping to, among other things, start/stop recording, pause recording, or power the device 20 on or off.

The recorder device 20 of FIG. 2A may further comprise a printed circuit board (PCB) 104 that may be configured to display information via the screen 28, capture audio (including voice and ambient noise), analyze the audio, store the audio in memory, receive/transmit information from/to the user device 30 or the mobile app 36 running on the user device 30, and/or wirelessly transmit audio (or analyzed portions thereof) to a server 14. The printed circuit board 104 may be relatively small in size, for example, approximately 23×27 millimeters with a thickness of approximately 1.5 millimeters. A variety of PCBs 104 may be used in accordance with embodiments disclosed herein including, for example, a two-sided PCB in which a display device 120 (FIG. 3) may be located on one surface of the PCB 104 adjacent to a display screen 28, and additional device components of the PCB 104 are located on a surface of the PCB 104 that is opposite the surface containing the display device 120. As discussed in detail with reference to FIG. 3, the printed circuit board 104 may include several components or units for carrying out the functions of the recorder device 20 discussed above. The functions of single components or units of the printed circuit hoard 104 may be separated into multiple components, units, or modules, or the functions of multiple components, units or modules may be combined into a single module or unit.

The recorder device 20 of FIG. 2A may further comprise a battery 106 that provides power to the recorder device 20 and may be charged via a magnetic charger 108 that may be physically and/or electronically coupled to the battery 106 at the back of the device 20. In various embodiments, the recorder device 20 may comprise a back part with universal fastening system 110 that can be used to attach the recorder device 20 to, among other things: an article, including an article of clothing. For example, the recorder device 20 may attach via a clip 112 that attaches to the universal fastening system 110 (FIG. 5); a pendant, via a pendant attachment 114 that attaches to the universal fastening system 110 (FIG. 6); or a watch (FIG. 7) or bracelet (FIG. 8) that may be attached to recorder device 20 via the universal fastening system 110. In some embodiments, the recorder device 20 may be mounted to an automobile dashboard or the like, attached to a pin that can be pinned to an article of clothing, or placed in charging and/or synchronization station that charges the device 20 and/or synchronizes the device 20 with a server 14, such as a cloud server. The screen 28, PCB 104, battery 106, and back part 110 of the recorder device 20 may mechanically be held in place via a casing 116. The casing 116 may be fabricated from brass and rhodium, gold plate, aluminum, or any other appropriate material. The casing 116 may include a cutout 117 through which a button 24 may configured to operate the recorder device 20 for such tasks as powering the recorder device 20 on or off, resetting the device 20, starting/stopping/pausing device 20 recording, and the like.

The exemplary recorder device 20 of FIG. 2B, like the recorder device 20 of FIG. 2A, may comprise: a screen 28 through which graphical (e.g., icons, figures, etc.) and/or textual information may be displayed; a printed circuit board (PCB) 104 that, as discussed with reference to FIGS. 2A and 3, may be configured to perform various functions of the recorder device 20, including displaying information via a display device 120, such as an LED array; a battery 106 that provides power to the recorder device 20 and may be charged via a charging station 119; and sound devices 134, such as piezo buzzers, that, as discussed with reference to FIG. 3, may provide audio notifications to a user 16 of the recorder device 20. The recorder device 20 shown in FIG. 2B, like the recorder device 20 of FIG. 2A, may also comprise a casing 116 that holds the screen 28, PCB 104, battery 106, and back part 110 of the recorder device 20 in place; and a cutout 117 through which a button 24 may be configured and programmed to operate the recorder device 20. The recorder device 20 of FIG. 2B may further comprise a touch sensor 113 that may be coupled to the display screen 23 and PCB 104 to provide touch screen functionality for operating the recorder device 20. In some embodiments, the touch sensor 113 may be coupled to a back surface of the display screen 23. The recorder device 20 of FIG. 2B may also comprise an interchangeable back fastening system 111 that can be used to clip the recorder device 20 to an article, including an article of clothing; and an interchangeable back fastening system 115 that can used to wear the recorder device 20 as a pendant of a necklace.

In accordance with various embodiments herein, an exemplary printed circuit board 104 of the recorder device 20 is illustrated in FIG. 3. In some embodiments, as shown in FIG. 3A, on one side of the printed circuit board 104, the PCB 104 may comprise, one or more processors 29, and a display device 120 that is coupled to a processor 29 (FIG. 3B) and is capable of displaying information via a screen 28 of the recorder device 20. A variety of display devices 120 may be used in accordance with embodiments disclosed herein, including, for example, a light emitting diode (LED) array, an organic light emitting diode (OLED), or any other suitable display device. In some embodiments, the display device 120 may configured to display information using approximately twenty (20) surface-mounted diodes (SMDs).

In some embodiments, as shown in FIG. 3B, on an opposite side of the PCB 104, the PCB 104 may comprise additional components or units. For example, the printed circuit board 104 may comprise one or more processors 29. A variety of processors 29 may be used in connection with the disclosed embodiments including, for example, a wireless micro-processing unit (MCU), a central processing unit (CPU), natural language processor (NLP) unit, neural processing unit (e.g., artificial intelligence (AI) chip), and/or graphics processing units (GPU). In some embodiments, a processor 29 may be capable of high-performance computing and/or GPU accelerated computing, for example. In various embodiments, the neural processing unit may comprise a chip on board (COB) configuration.

In various embodiments, where a processor 29 is a neural processing unit, the processor 29 may be trained to identify a voice as being that of a particular person, recognize particular noises and sounds, perform speech-to-text translations, and recognize emotional and prosodic aspects of a speaker's voice. For example, during a recorder device 20 setup, which includes coupling the recorder device 20 to a user device 30, a user 16 may choose to identify his/her voice by speaking a sample text for some period of time so that the processor 29 learns to recognize the user's 16 voice using techniques such as voice biometrics. As a result, processor 29 of a recorder device 20 or a server 14 may be trained to determine, among other things, whether the voice belongs the user 16. Similarly, when another person's voice is repeatedly recorded by the recorder device 20, a processor of the recorder device 20 or a server 14 may trained to determine that the voice belongs to this person. As a result, the recorder 20 or server 14 may be able to tag transcribed notes with authorship information. In some embodiments, notes may comprise: text, with or without punctuation; lists, including billeted lists; audio or textual reminders; or voice memos.

In another example, a processor 29 may be trained to perform speech-to-text translations of recorded audio, which may involve recognizing and extracting human speech from an audio recording and transcribing the speech into text (or notes). In another example, a processor 29 may be trained to identify ambient noises or sounds captured by the recorder device 20 (e.g., crowd, networking, office, phone call, home, car, airport, park, grocery store, street, concert, hospital, night club, sporting event, etc.). This information may then be used to provide information about the environment in which a recording was made e.g., a person may search his or her notes using a search term that identifies a particular environment (e.g., park, etc.), and notes taken in the park will be retrieved. In yet another example, a processor 29 may be trained to analyze the pitch, tone, emotion, and prosodic aspects of a speaker's voice. In other example, a processor 29 may be trained to recognize voice or sound commands (e.g., clap, finger snap, or keywords, etc.) to control the function of a recorder device 20. The processor 29 may also be trained to perform more complex tasks such as extracting the subject of one more notes or messages, summarizing the results, and providing a summary to a user 16 on a periodic basis (e.g., daily, weekly, or monthly). Over time, by using artificial intelligence, the neural algorithms of a processor 29 or the neural algorithms of a server 14 may teach themselves to perform such analysis with increasing speed, efficiency and accuracy.

In some embodiments, the printed circuit board 104 of FIG. 3B may also comprise a communication interface 124 (e.g., 5G, Wi-Fi, Bluetooth Low Energy (BLE) circuit, etc.) may be used for two-way communication between a recorder device 20 and a user device 30, a server 14, such as a cloud server, or another recorder device 20.

The printed circuit board 104 of FIG. 3B may further comprise two or more microphones 26 that are controlled by a processor 29 to record/capture voices as well as ambient sounds or noise. So, instead of cancelling ambient sounds or noise, which is typical of feature of microphones and/or voice recording systems, the microphones 26 are configured to capture ambient sounds or noise so that it can be analyzed to provide useful information. A variety of microphones 26 may be used in accordance with embodiments disclosed herein including, for example, digital micro-electro-mechanical (MEMS) microphones, passive listening microphones, smart microphones for directional listening, and any other electronic microphone.

In some embodiments, the location of one microphone 26a on the printed circuit board 104 may be selected to optimize recording of a user's voice. While the location of another microphone 26b may be configured on the printed circuit board 104 to optimize recording ambient noise or sound. For example, in some embodiments, microphone 26a may be oriented in a direction that is one-hundred-eighty degrees (180°) from the direction in which microphone 26b is oriented, and vice-versa, so that microphone 26a captures all or mostly voice signal(s) and the other microphone 26b captures all or mostly ambient noise/sound signals. Moreover, in some embodiments, one microphone 26a may be configured to listen at a distance that may be different from a distance at which another microphone 26b is configured to listen. By configuring one microphone 26a to listen at a distance that is different from another microphone 26b, the amount of unwanted noise captured from each microphone may be reduced, and the quality of voice audio recording increased.

Furthermore, by using two or more microphones 26, techniques such as adaptive stereo filtration may be used to decrease unwanted audio in a recording and increase the quality of audio that is wanted. For example, double-channel adaptive stereo filtration techniques may lower both transmission broadband non-stationary noises (e.g., speeches, radio broadcasting, grain noises, etc.) and periodic noises (e.g., vibrations, electromagnetic interference, etc.). Where double-channel adaptive stereo filtration techniques are used, the ratio of signals and noise in each channel may differ. For example, a channel with desired dominating signals (e.g., voice) may be designated a main channel (e.g., the channel with higher quality voice audio), while a channel with dominating noise is designated a support channel. In some embodiments, the signal-to-noise ratio in a main channel may be improved by processing audio recorded by the recorder device 20 in real time and identifying from which microphone 26 the signal with voice audio is stronger, and then strengthening the signal from that microphone 26. In accordance with embodiments disclosed herein, the use of two or more microphones 26 that are recording simultaneously and at 180 degrees directionally from each other, may result in stereo audio recording for which adaptive filtration and/or recognition techniques may be used. For example, in some embodiments, a cloud server 14 (or a processor 29 of the recorder device 20) may process audio that is simultaneously recorded by microphones 26 to recognize channel(s) where voice quality is better or worse, designate the channel where voice quality is the best as a main channel, and designate the remaining channel(s) as support channel(s). Then, when an ambient sound or noise is detected on a supporting channel, the server 14 or processor 29 may subtract the ambient sound or noise from the audio stream of the main channel, thereby increasing the voice audio quality.

The printed circuit board 104 of FIG. 3B may further comprise memory 128, such as flash memory or EE prom memory. The memory 128 may be used by a processor 29 for locally storing audio that is recorded/captured by a recorder device 20; for example, in situations where a wireless connection 12 between the recorder device 20 and a user device 30/server 14 is unavailable and the recorder device 20 is unable to transmit recorded audio (or other information) to the user device 30/server 14. Once the wireless connection 12 between the recorder device 20 and the user device 30/server 14 is restored, a processor 29 may automatically transmit the recorded/captured audio from local memory 29 to the user device 30.

The printed circuit board 104 of FIG. 3B may also comprise components for controlling the recorder device 20. For example, an accelerometer 130, such as a 3-axes accelerometer, may be used so that a user 16 of the recorder device 20 can tap the display screen 28 (FIG. 2) to turn power to the device 20 on or off, or perform other functions. In another example, a button 24 may turn power to the recorder device 20 on or off. In various embodiments, other recorder device 20 controlling functions may be assigned to the button 24, for example, adjusting the recording quality of the device 20, resetting the device 20 to its factory settings (e.g., by holding button down for some number of seconds), etc. In some embodiments, the printed circuit board 104 may also comprise a sound device(s) 134, such as a piezo buzzer(s), that may be used to provide audio feedback to a user 16 (e.g., a beep to confirm the start/end of recording; to confirm that a user 16 has received and/or read a message, e-mail, or other communication from the recorder device 20; a reminder; or to track the location of the device 20 if it is misplaced, etc.).

In accordance with various embodiments herein, and with reference to FIG. 4, simplified block diagrams showing exemplary interactions among a recorder device 20, a user device 30, and a server(s) 14 are illustrated. For example, in FIG. 4A, an exemplary interaction is illustrated in which recorded audio (i.e., raw audio) is analyzed by the recorder device 20 itself rather than sending it to a server 14 for analysis. At 200, the recorder device 20 is powered on. As previously discussed, this may be done using an on/off button 24 (FIGS. 2 and 3) of the recorder device 20 via voice activation, or tapping a screen 28 of the device 20. Once the recorder device 20 is powered on, at 202, the microphones 26 of the recorder device 20 may begin recording. The microphones 26 may record passively (i.e., without user activation), or start recording upon user activation (e.g., by tapping the device screen 28, pressing a button 24, or speaking a learned voice command). In the case of passive recording, the recorder device 20 is constantly listening, recording, and analyzing audio. Here, when no human voice is detected for more some pre-determined period of time (e.g., five seconds), the recorder device 20 may automatically go into a hibernation mode. In the case of active recording, the recorder device 20 starts listening, recording, and analyzing audio when a user 16 manually starts the recording process (e.g., by tapping the device screen 28, pressing a button 24, or speaking a learned voice command), and manually ends it (e.g., by tapping the device screen 28, pressing a button 24, or speaking a learned voice command). At 204, a part of the audio analysis performed by the recorder device 20 involves segregating voice audio signals from ambient noise audio signals in a recorded audio stream. Ideally, because one microphone 26 is configured to record voice and another microphone 26 is configured to record ambient noise, the voice-recording microphone 26 may have limited amounts of ambient noise to segregate, and vice-versa. At 206, segregated ambient noise audio is analyzed to identify environmental surroundings etc. and, at 208, the results of the analysis (e.g., file(s), data) are saved or mirrored to a mobile app 36 on the user device 30.

At 210, segregated voice audio is analyzed to identify a command for controlling the recorder device 20. If a voice command is detected, at 212, a processer 29 of the recorder device 20 is notified. If a voice command is not detected, at 214, the voice audio is analyzed for tone, emotion, and/or prosodic features and, at 216, the results of the analysis (e.g., file(s), data) are sent to a mobile app 36 on the user device 30. At 218, the voice audio is transcribed from speech to text and, at 220, the transcribed text file(s) or data are sent to the mobile app 36 on the user device 30. In some embodiments, a natural language processor (NLP) may be used at step 218 to extract keywords and hashtags from the text, format the text, and categorize the text. In some embodiments, a hashtag may be used to categorize information into “virtual folders.” For example, a user 16 may say “Hashtag, May 24 meeting notes, follow up with vendors, call new supplier,” the NLP will detect the hashtag, and categorize the text into a virtual “May 24 Meeting” folder. And, if the voice recording contains a shopping list, the resulting note will be formatted as a bulleted list and assigned an appropriate mobile app 36 category (e.g., calendar, diary notes, music, lists (e.g., shopping list, checklist, to-do list, etc.), reminders, social media, etc.).

At 222, the results of the audio analysis performed by the recorder device 20 are received by the mobile 36 that is located on the user device 30. At 224, unless NLP processing has already been performed on the recorder device 20, the results are meta tagged (including with a GPS location identified by the user device 30), and keyword and concept analysis is performed using the results, as discussed with reference to FIG. 1. At 226, results of the audio analysis performed by the recorder device 20 may also be stored on a cloud server 14.

In another embodiment, the exemplary interaction of FIG. 4A may be modified at 222. In particular, as illustrated in FIG. 4B at 225, the results of the audio analysis performed by the recorder device 20 may instead be sent to a server 14, such as cloud server, and later mirrored on a user device 30 at 221 by the server 14.

In another example, in FIG. 4C, an exemplary interaction is illustrated in which recorded audio (i.e., raw audio) is analyzed by a server 14. Here again, at 300, the recorder device 20 is powered on. As discussed with reference to FIG. 4A, once the recorder device 20 is powered on, at 302, the recorder device 20 microphones 26 may begin recording. Here, because the audio is not processed on the recorder device 20, at 304, the raw audio is sent to a mobile app 36 on the user device 30. At 306, the raw audio files are sent to a server 14 for processing and analysis. At 308, the raw audio is received by the server 14.

At 310, a part of the audio analysis performed by the server 14 involves segregating voice audio from ambient noise audio in a recorded audio stream. At 312, the voice audio is analyzed for tone, emotion, and/or prosodic features and, at 314, the results of the analysis (e.g., file(s) or data) are saved on a server 14 (e.g., a cloud server) and mirrored on the mobile app 36 on the user device 30. At 316, the voice audio is transcribed from speech to text and, at 318, the transcribed text tile(s) or data are saved on a server 14 (e.g., a cloud server) and mirrored on the mobile app 36 on the user device 30. At 320, segregated ambient noise audio is analyzed to identify environmental surroundings and, at 322, the results of the analysis (e.g., file(s), data) are saved on a server 14 (e.g., a cloud server) and mirrored on the mobile app 36 on the user device 30. At 324, the analysis results are received by the mobile app 36 on the user device 30. And, at 326, unless NLP processing been performed on the server 14, the results are meta tagged (including with a GPS location identified by the user device 30), and keyword and concept analysis is performed using the results, as discussed with reference to FIGS. 1A an 1B. The resulting notes etc. may also be stored on a server 14, such as a cloud server.

In another embodiment, the exemplary interaction of FIG. 4C may be modified at 304, 306, and 308. In particular, as illustrated in FIG. 4D at 304, the raw audio is sent from the recorder device 20 directly to a server 14, such as a cloud server, for processing and analysis. And at 308, the raw audio is received from the recorder device 20 at the server 14.

Based on the foregoing embodiments of the present disclosure, highly integrated recording systems 10 are provided that are capable of recording voice and ambient noise and analyzing both using artificial intelligence—including machine and deep learning and natural language processing—to generate notes, categorize the notes, provide information about the environment in which the notes were taken, and even determine the emotion or tone of the recorded speaker to add context to the generated notes. A cloud server or network 14 is also provided that is capable of receiving and storing raw voice and ambient noise audio received from a portable recorder device 20, and/or analyzing such audio using artificial intelligence to similarly generate notes, categorize the notes, provide information about the environment in which the notes were taken, and determine the emotion or tone of the recorded speaker to add context to the generated notes.

Furthermore, because notes generated by the portable recorder device 20 may be synched directly to a cloud server or network 14, or notes may be generated on the cloud server or network 14 itself, such notes may be mirrored on any wireless-communication enabled devices 30 at any time or place to provide a highly integrated and portable audio recording system. Additionally, by having a highly integrated system 10 that comprises a cloud server or network 14 that may control an application 36, and that sits above a recorder device 20, multiple users 16 may collaborate with one another. For example, a user 16 may send a message to another user 16 via the application 36 or a user 16 may send or receive messages directly to/from users of collaboration platforms such as Slack, Salesforce, Emails, Webchat, etc. In this case, the user 16 would receive an audible notification on the recorder device 20 that such a message has been received. Moreover, the use of artificial intelligence allows a recorder device 20 and/or a server or network 14 to be trained to identify particular voices or sounds, proper nouns, names, or usage patterns such as the type of notes a particular user 16 takes, the length and/or subject of the notes, and the time and location of a note, etc.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims cover be construed to all such equivalent variations as fall within the true spirit and scope of the invention.

What is claimed is:

1. A system for recording audio, comprising:
a portable recorder device comprising two or more microphones, one or more processors, and a communication interface,
wherein one of the two or more microphones is operable to capture a voice signal of the audio and an other of the two or more microphones is operable to capture an ambient noise signal of the audio,
wherein at least one of the one or more processors of the portable recorder device is operable to analyze the voice signal to generate voice data, and
wherein at least one the one or more processors of the portable recorder device is operable to analyze the ambient noise signal to generate noise data;
one or more servers coupled to the portable recorder device via the communication interface,
wherein the at least one of one or more servers is operable to receive the voice data and the noise data from the portable recorder device via the communication interface; and
a user device wirelessly coupled to the one or more servers, wherein an application on the user device is operable to receive the voice data and the noise data.

2. The system of claim 1, wherein the two or more microphones are operable to simultaneously capture the audio.

3. The system of claim 1, wherein a directional orientation of the one of the two or more microphone is approximately 180 degrees from a directional orientation of the other of the two or more microphones.

4. The system of claim 1, wherein the at least one of the one or more processors of the portable recorder device is operable to analyze the voice signal to generate the voice data using artificial intelligence.

5. The system of claim 1, wherein the at least one of the one or more processors of the portable recorder device is operable to analyze the ambient noise signal to generate the noise data using artificial intelligence.

6. The system of claims 4 and 5, wherein the at least one of the one or more processors comprises a natural language processor (NLP) unit, a neural processing unit, or a graphics processing units (GPU).

7. The system of claim 6, wherein the neural processing unit is an artificial intelligence (AI) chip.

8. The system of claim 1, wherein the portable recorder device is a wearable device.

9. The system of claim 1, wherein the voice data comprises text translated from the voice signal using a speech-to-text conversion technique, prosodic characteristics of speech corresponding to an author of the voice signal, or emotional characteristics of the speech corresponding to the author of the voice signal.

10. The system of claim 9, wherein the speech-to-text conversion technique comprises natural language processing.

11. The system of claim 1, wherein the noise data comprises information corresponding an environment in which the ambient noise signal was captured.

12. The system of claim 1, wherein the at least one of the one or more servers is a cloud server.

13. The system of claim 1, wherein the application on the user device is operable to meta tag, assign a location to, or provide conceptual analysis of the voice data and the noise data.

14. A system for recording audio, comprising:
a portable recorder device comprising two or more microphones, one or more processors, and a communication interface,
wherein one of the two or more microphones is operable to capture a voice signal of the audio and an other of the two or more microphones is operable to capture an ambient noise signal of the audio;
one or more servers coupled to the portable recorder device via the communication interface,
wherein at least one of the or more servers is operable to receive the voice signal and the ambient noise signal from the portable recorder device via the communication interface,
wherein the at least one of the one or more servers is operable to analyze the voice signal to generate voice data, and
wherein the at least one of the one or more servers is operable to analyze the ambient noise signal to generate noise data; and
a user device wirelessly coupled to the one or more servers, wherein an application on the user device is operable to receive the voice data and the noise data from the at least one of the one or more servers.

15. The system of claim 14, wherein the two or more microphones are operable to simultaneously capture the audio.

16. The system of claim 14, wherein a directional orientation of the one of the two or more microphone is approximately 180 degrees from a directional orientation of the other of the two or more microphones.

17. The system of claim 14, wherein the at least one of the one or more servers is operable to analyze the voice signal to generate the voice data using artificial intelligence.

18. The system of claim 14, wherein the at least one of the one or more servers is operable to analyze the ambient noise signal to generate the noise data using artificial intelligence.

19. The system of claim 14, wherein the portable recorder device is a wearable device.

20. A system for recording audio, comprising:
a portable recorder device comprising two or more microphones, one or more processors, and a communication interface,
wherein one of the two or more microphones is operable to capture a voice signal of the audio and an other of the two or more microphones is operable to capture an ambient noise signal of the audio,
wherein at least one of the one or more processors of the portable recorder device is operable to analyze the voice signal to generate voice data, and
wherein at least one the one or more processors of the portable recorder device is operable to analyze the ambient noise signal to generate noise data;
a user device coupled to the portable recorder device via the communication interface,
wherein the user device is operable to receive the voice data and the noise data from the portable recorder device via the communication interface,
one or more servers coupled to the user device,
wherein the user device is operable to transmit the voice data and the noise data to at least one of the one or more servers,
wherein the at least one of the one or more servers is operable to receive and store the voice data and the noise data, and
wherein the at least one of the one or more servers is operable to mirror the voice data and the noise data in an application on the user device.

21. The system of claim 20, wherein the two or more microphones are operable to simultaneously capture the audio.

22. The system of claim 20, wherein a directional orientation of the one of the two or more microphone is approximately 180 degrees from a directional orientation of the other of the two or more microphones,

23. The system of claim 20, wherein the at least one of the one or more processors of the portable recorder device is operable to analyze the voice signal to generate the voice data using artificial intelligence.

24. The system of claim 20, wherein the at least one of the one or more processors of the portable recorder device is operable to analyze the ambient noise signal to generate the noise data using artificial intelligence.

25. The system of claim 20, wherein the portable recorder device is a wearable device.

26. A system for recording audio, comprising:
a portable recorder device comprising two or more microphones, one or more processors, and a communication interface,
wherein one of the two or more microphones is operable to capture a voice signal of the audio and an other of the two or more microphones is operable to capture an ambient noise signal of the audio;
a user device coupled to the portable recorder device via the communication interface,
wherein the user device is operable to receive the voice signal and the ambient noise signal from the portable recorder device via the communication interface;
one or more servers coupled to the user device,
wherein the user device is operable to transmit the voice signal and the ambient noise signal to at least one of the one or more servers,
wherein the at least one of the one or more servers is operable to analyze the voice signal to generate voice data,
wherein the at least one the one or more servers is operable to analyze the ambient noise signal to generate noise data,
wherein the at least one of the one or more servers is operable to store the voice data and the noise data, and
wherein the at least one of the one or more servers is operable to mirror the voice data and the noise data in an application on the user device.

27. The system of claim 26, wherein the two or more microphones are operable to simultaneously capture the audio.

28. The system of claim 26, wherein a directional orientation of the one of the two or more microphone is approximately 180 degrees from a directional orientation of the other of the two or more microphones.

29. The system of claim 26, wherein the portable recorder device is a wearable device.

30. A portable recorder device for capturing audio, the portable recorder device comprising:
one or more processors powered by a battery;
a communication interface;
a display screen coupled to at least one of the one or more processors;
two or more microphones,
wherein one of the two or more microphones is operable to capture a voice signal of the audio and an other of the two or more microphones is operable to capture an ambient noise signal of the audio,
wherein the at least one of the one or more processors is operable to analyze the voice signal to generate voice data using artificial intelligence,
wherein at least one the one or more processors is operable to analyze the ambient noise signal to generate noise data using artificial intelligence,
wherein the voice data comprises text translated from the voice signal using a speech to text conversion technique, prosodic characteristics of speech corresponding to an author of the voice signal, or emotional characteristics of the speech corresponding to the author of the voice signal,
wherein the noise data comprises information corresponding an environment n which the ambient noise signal was captured,
wherein the portable recorder device is operable to transmit the voice data and the noise data to a server via the communication interface,
wherein the server is a cloud server,
wherein the cloud server is operable to transmit the voice data and the noise data to an application on a user device, and
wherein the application on the user device is operable to meta tag, assign a location to, or provide conceptual analysis of the voice data and the noise data.
